(19) United States
(12) Patent Application Publication
(10) Pub. No.: US 2024/0195921 A1
(43) Pub. Date: Jun. 13, 2024

(54) User Notifications Handling in a Communications Network

(71) Applicant: Telefonaktiebolaget LM Ericsson (Publ), Stockholm (SE)

(72) Inventors: Miguel Angel Puente Pestaña, Madrid (ES); Miguel Angel Muñoz De La Torre Alonso, Madrid (ES); Antonio Cañete Martinez, Madrid (ES)

(21) Appl. No.: 18/285,107

(22) PCT Filed: May 27, 2021
(86) PCT No.: PCT/EP2021/064172

§ 371 Date: Sep. 29, 2023

(30) Foreign Application Priority Data
Mar. 30, 2021 (EP) 21382258.8

(51) Int. Cl. H04M 15/00

(52) U.S. Cl. CPC H04M 15/852; H04M 15/67; H04M 15/64; H04M 15/66

(57) ABSTRACT

A method for handling user notifications in a communications network. The method comprises receiving an indication that a second entity supports a user notification type; determining that a user notification of the user notification type shall be transmitted to the second entity, the user notification comprising a user identity and a notification content; selecting the second entity for delivering the user notification of the user notification type to the user; and transmitting to the second entity the user notification including the user identity and the notification content. The method may be performed by a Network Exposure Function (NEF), a Service Capability Exposure Function (SCEF), a Policy Control Function (PCF), a Policy and Charging Rules Function (PCRF), a Charging Function (CHF), or an Online Charging System (OCS). The second entity may be an application server, particularly a push notification server or a Service Capability Server (SCS), or a or a Mobile Network Operator Application Function, MNO AF.

### TECHNICAL FIELD

The present invention generally relates to user notifications handling in communication networks, and more specifically, the invention relates to the notification of quota exhaustion events.

### BACKGROUND

A Mobile Network Operator Application Function (MNO AF) is an Application Function (AF) owned by the MNO which may be used to interact with a content provider entity (e.g. another AF or an application server) or an application client in the User Equipment (UE) to for example policy provisioning in multimedia streaming scenarios or data collection in analytics scenarios.

Quota management in communication networks comprises granting a specific amount in respect to the number of data or temporal units (e.g. bytes, seconds) to be used or consumed by a user of the communication network. Usually the quota is established on a per user basis and depends on the user's subscription plan. In 5G networks, the Network Function (NF) in charge of handling quota management procedures is the Charging Function (CHF).

Push technology, push notifications or server push, is a style of communication where a request for transacting a message is initiated by a publisher, central or push server. The push server triggers the transmission of a message or push notification to the terminal of the receiving user. In mobile networks, push notifications are sent from the push server to the User Equipment of the user and are typically used to display information pertaining to the applications or the operating system running in the User Equipment, for example chat messages, operating system updates, etc.

One aspect of quota management is that users need to be notified when their quota is expired or about to exhaust, so that they are aware of this fact and they can recharge and reestablish the quota, or otherwise adapt their communication behaviour. To this end, operators use solutions such as HTTP redirection and SMS messages. HTTP redirection redirects the user towards specific servers within the operator's domain that host quota refill services. SMS messages can be used to make the user aware of the quota exhaustion, possibly further including a link to the quota refiling service.

These solutions are problematic when used for quota exhaustion notifications in mobile networks. HTTP redirection only works when the traffic is not encrypted, since the redirection request is an application-level request. If the traffic is encrypted, the HTTP header is not visible, and the HTTP redirection request cannot be generated towards the user. In turn, some users may not be responsive to SMS messages. A factor is that SMS's usage is declining. Additionally, it's likely that the users confuse relevant quota exhaustion messages with other promotion or spam SMS messages that they automatically ignore.

### SUMMARY

An object of the invention is to enable handling user notifications in a communications network via an application function, particularly the notification of quota exhaustion events using push notifications or an MNO AF. The notification of quota exhaustion events includes notifying users of when the quota is about to exhaust or when it's already exhausted and the user is requested to carry out a refill.

A first aspect of the invention relates to a method for handling user notifications in a communications network. The method comprises receiving an indication that a second entity supports a user notification type, particularly wherein the indication is received from the second entity or from a user data repository; determining that a user notification of the user notification type shall be transmitted to a user equipment associated with a subscriber of the communications network, the user notification comprising a user identity of the subscriber and a notification content; selecting the second entity for delivering the user notification of the user notification type to the user equipment; and transmitting to the second entity the user notification including the user identity and the notification content. The method may further comprise receiving from a third entity a notify message including the user identity and the notification content, wherein the transmission of the user notification is determined based on the received notify message. The user notification and/or notify message may further include the IP address of the user equipment of the user. The notification content may comprise a URL to access a service related to the user notification, particularly wherein the service is a web service. The notification content may comprise a notification text. The user notification type may be a quota exhaustion notification.

The method may further comprise receiving from the second entity an operating system identifier; transmitting to a fourth entity a subscription request for user equipment register events including the operating system identifier; receiving from the fourth entity, in response to a register event of the user equipment, wherein the operating system of the user equipment corresponds to the operating system identifier, a notification of the user equipment register event including the user identity, an IP address of the user equipment and the operating system identifier; transmitting to the second entity a registration request for the user equipment, including the user identity and the IP address; and transmitting to the third entity a request for quota exhaustion notifications including the user identity.

The method may further comprise receiving from the second entity a user identity; and transmitting to the third entity a request for quota exhaustion notifications including the user identity.

In one embodiment of the method, the first entity is a Network Exposure Function (NEF) a Service Capability Exposure Function (SCEF) a Policy and Charging Rules Function (PCRF) a Policy Control Function (PCF) a Charging Function (CHF) or an Online Charging System (OCS); wherein the second entity is an application server, particularly a push notification server, a Service Capability Server (SCS) or a Mobile Network Operator Application Function (MNO AF).

In a further embodiment of the method, the first entity is a Network Exposure Function (NEF) a Service Capability Exposure Function (SCEF) wherein the second entity is an application server, particularly a push notification server, a Service Capability Server (SCS) or a Mobile Network Operator Application Function, MNO AF; wherein the third entity is a Charging Function (CHF) an Online Charging System (OCS) a Policy and Charging Rules Function (PCRF) or a Policy Control Function (PCF); and wherein the fourth entity is an Access and Mobility Management Function (AMF) or a Mobility Management Entity (MME).

A second aspect of the invention relates to method for handling user notifications in a communications network. The method comprises transmitting to a second entity an indication of the support of a user notification type including at least one of a user identity of a subscriber of the communications network and an operating system identifier; receiving from the second entity a user notification of the user notification type including the user identity and a notification content; transmitting to a user equipment identified by the user identity a further user notification of the user notification type including the notification content. The user notification may comprise the IP address of the user equipment of the user. The notification content may comprise a URL to access a service related to the user notification, particularly wherein the service is a web service. The notification content may comprise a notification text. The user notification type may be a quota exhaustion notification.

In a further embodiment of the method, the first entity is an application server, particularly a push notification server, a Service Capability Server (SCS) or a Mobile Network Operator Application Function, MNO AF; and wherein the second entity is a Network Exposure Function (NEF) a Service Capability Exposure Function (SCEF) a Charging Function (CHF) an Online Charging System (OCS) a Policy and Charging Rules Function (PCRF) or a Policy Control Function (PCF).

Other aspects of the invention relate to mobile network nodes, particularly a Network Exposure Function and an application server (e.g. a push server), each configured to perform the respective methods as described herein. Other aspects of the invention relate to computer program and computer program products.

Advantageously, the solution disclosed herein enables the usage of an application handled by the operator towards its subscribers (also denoted as users) for the quota exhaustion notifications. That is, the application is usually offered by operators so that the users can manage their subscription package. Using the solution disclosed herein, the quota exhaustion notifications can be displayed as notifications of the operator's application.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The invention may best be understood by referring to the following description and accompanying drawings that are used to illustrate particular embodiments of the invention. In the drawings:

FIG. 1 is a networked system in accordance with particular embodiments of the solution described herein;

FIG. 2 is a signaling diagram illustrating a procedure according to particular embodiments of the solution described herein;

FIG. 3 is a signaling diagram illustrating a procedure according to particular embodiments of the solution described herein;

FIG. 3A is a signaling diagram illustrating a procedure according to particular embodiments of the solution described herein;

FIG. 3B is a signaling diagram illustrating a procedure according to particular embodiments of the solution described herein;

FIG. 3C is a signaling diagram illustrating a procedure according to particular embodiments of the solution described herein;

FIG. 4A is a flowchart illustrating a method performed by a mobile network node according to particular embodiments of the solution described herein;

FIG. 4B is a flowchart illustrating a method performed by a mobile network node according to particular embodiments of the solution described herein;

FIG. 4C is a flowchart illustrating a method performed by a mobile network node according to particular embodiments of the solution described herein;

FIG. 4D is a flowchart illustrating a method performed by a mobile network node according to particular embodiments of the solution described herein;

FIG. 5 is a flowchart illustrating a method performed by a mobile network node according to particular embodiments of the solution described herein;

FIG. 6 is a block diagram of a mobile network node configured in accordance with particular embodiments of the solution described herein;

FIG. 7 is a block diagram of a mobile network node configured in accordance with particular embodiments of the solution described herein;

FIG. 8 is a networked system in accordance with particular embodiments of the solution described herein.

### DETAILED DESCRIPTION

The invention will now be described in detail with reference to the accompanying drawings, in which examples of embodiments or implementations of the invention are shown. The invention may, however, be embodied or implemented in many different forms and should not be construed as limited to the embodiments set forth herein. Rather, these embodiments are provided so that this disclosure will be thorough and complete, and will fully convey the scope of the present invention to those skilled in the art. It should also be noted that these embodiments are not mutually exclusive. Components from one embodiment may be tacitly assumed to be present/used in another embodiment. These embodiments of the disclosed subject matter are presented as teaching examples and are not to be construed as limiting the scope of the disclosed subject matter. For example, certain details of the described embodiments may be modified, omitted, or expanded upon without departing from the scope of the described subject matter.

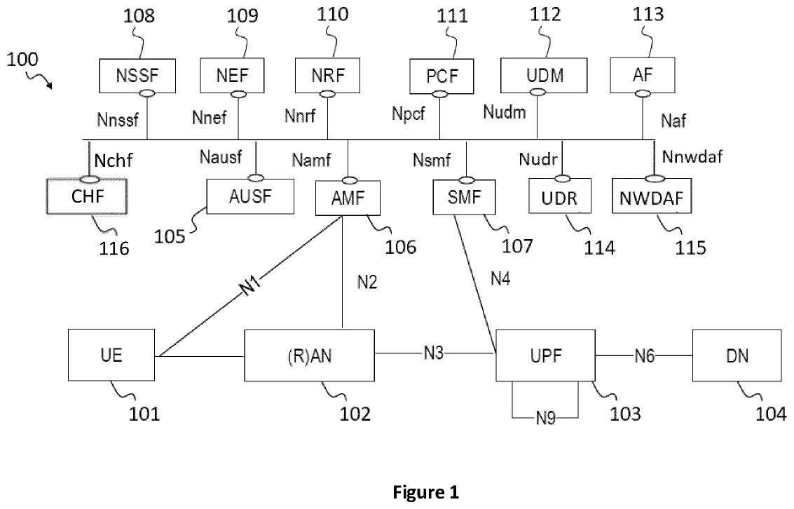

The example embodiments described herein arise in the context of a telecommunications network, including but not limited to a telecommunications network that conforms to and/or otherwise incorporates aspects of a fifth generation (5G) architecture. FIG. 1 is an example networked system 100 in accordance with example embodiments of the present disclosure. FIG. 1 specifically illustrates User Equipment (UE) 101, which may be in communication with a (Radio) Access Network (RAN) 102 and Access and Mobility Management Function (AMF) 106 and User Plane Function (UPF) 103. The AMF 106 may, in turn, be in communication with core network services including Session Management Function (SMF) 107 and Policy Control Function (PCF) 111. The core network services may also be in communication with an Application Server/Application Function (AS/AF) 113. Other networked services also include Network Slice Selection Function (NSSF) 108, Authentication Server Function (AUSF) 105, User Data Management (UDM) 112, Network Exposure Function (NEF) 109, Network Repository Function (NRF) 110, Charging Function (CHF) 116 and Data Network (DN) 104. In some example implementations of embodiments of the present disclosure, an AMF 106, SMF 107, UPF 103, PCF 111, AUSF 105, NRF 110, UDM 112, NEF 109, AF 113, and NSSF 108 are each considered to be an NF. One or more additional instances of the network functions (NF) may be incorporated into the networked system.

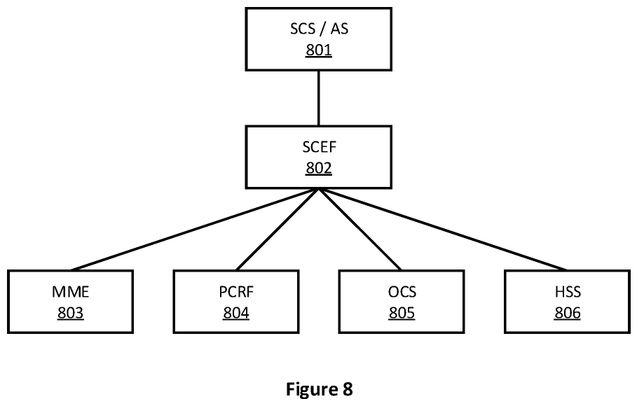

FIG. 8 is an example networked system in accordance with example embodiments of the present disclosure. FIG. 8 specifically illustrates an architecture of the 3GPP's Evolved Packet System (EPS). The architecture in FIG. 8 comprises a Service Capability Server/Application Server (SCS/AS) 801 connected to a Service Capability Exposure Function (SCEF) 802. In turn the SCEF is connected to a Mobility Management Entity (MME) 803, a Policy and Charging Rules Function (PCRF) 804, an Online Charging System (OCS) 805 and a Home Subscriber Server (HSS) 806.

The solution described herein aims to enable handling user notifications in a communications network via an application function, particularly the notification of quota exhaustion events using push notifications or an MNO AF. The notification of quota exhaustion events includes notifying users of when the quota is about to exhaust or when it is already exhausted and the user is requested to carry out a refill.

Three scenarios are described. A first scenario using push notifications, in which the push notifications are not linked to any application. Today these notifications are used e.g. to notify of OS installation updates, to recommend certain settings, etc. A second scenario also using push notifications, in which application push notifications are used. Application push notifications are linked to applications, so when they are showed to the user they appear as coming from the application. This scenario can apply when the user has the operator's application installed and the notifications may appear as notifications from the operator's application. And a third scenario in which an MNO AF is used to deliver the notification to the UE. In this scenario the notification is displayed to the user by an MNO application client at the UE.

To achieve such object, this disclosure provides a method for handling user notifications performed in a 5G Core (5GC) scenario by an application server (e.g. a push server) 201, a MNO AF 301, a NEF 109, a CHF 116, an AFM 106, a PCF 111, a UE 101 and a UDR 114. This disclosure describes the solution in a 5GC deployment. Nevertheless, it also applies to an EPS deployment. If performed in a EPS scenario, the method is performed mutatis mutandis by an Service Capability Server/Application Server (SCS/AS) 801, a Service Capability Exposure Function (SCEF) 802, a Mobility Management Entity (MME) 803, a Policy and Charging Rules Function (PCRF) 804, an Online Charging System (OCS) 805, a Home Subscriber Server (HSS) 806, and a UE 101. Herein, the functionality of the application server corresponds to the functionality of the SCS/AS, the functionality of the NEF corresponds to the functionality of the SCEF, the functionality of the AMF corresponds to the functionality of the MME, the functionality of the CHF corresponds to the functionality of the OCS, the functionality of the PCF corresponds to the functionality of the PCRF, and the functionality of the UDR corresponds to the functionality of the HSS 806.

A first aspect of the method is performed by a first entity. The method comprises receiving an indication that a second entity supports a user notification type, particularly wherein the indication is received from the second entity or from a user data repository; determining that a user notification of the user notification type shall be transmitted to the second entity, the user notification comprising a user identity and a notification content; selecting the second entity for delivering the user notification of the user notification type to the user; and transmitting to the second entity the user notification including the user identity and the notification content. The method may further comprise receiving from a third entity a notify message including the user identity and the notification content, wherein the transmission of the user notification is determined based on the received notify message. The user notification and/or notify message may further include the IP address of the user equipment of the user. The notification content may comprise a URL to access a service related to the user notification, particularly wherein the service is a web service. The notification content may comprise a notification text. The user notification type may be a quota exhaustion notification.

The method may further comprise receiving from the second entity an operating system identifier; transmitting to a fourth entity a subscription request for User Equipment register events including the operating system identifier; receiving from the fourth entity, in response to a register event of a User Equipment whose operating system corresponds to the operating system identifier, a notification of the User Equipment register event including the user identity, the User Equipment IP address and the operating system identifier; transmitting to the second entity a registration request for the User Equipment, including the user identity and the User Equipment IP address; and transmitting to the third entity a request for quota exhaustion notifications including the user identity.

The method may further comprise receiving from the second entity a user identity; and transmitting to the third entity a request for quota exhaustion notifications including the user identity.

In one embodiment of the method, the first entity is a Network Exposure Function (NEF) a Service Capability Exposure Function (SCEF) a Policy and Charging Rules Function (PCRF) a Policy Control Function (PCF) a Charging Function (CHF) or an Online Charging System (OCS); wherein the second entity is an application server, particularly a push notification server, a Service Capability Server (SCS) or a Mobile Network Operator Application Function (MNO AF).

In a further embodiment of the method, the first entity is a Network Exposure Function (NEF) a Service Capability Exposure Function (SCEF) wherein the second entity is an application server, particularly a push notification server, a Service Capability Server (SCS) or a Mobile Network Operator Application Function, MNO AF; wherein the third entity is a Charging Function (CHF) an Online Charging System (OCS) a Policy and Charging Rules Function (PCRF) or a Policy Control Function (PCF); and wherein the fourth entity is an Access and Mobility Management Function (AMF) or a Mobility Management Entity (MME).

A second aspect of the method is performed by a further first entity in a communications network. The method comprises transmitting to a second entity an indication of the support of a user notification type including at least one of a user identity and an operating system identifier; receiving from the second entity a user notification of the user notification type including the user identity and a notification content; transmitting to a user equipment identified by the user identity a further user notification of the user notification type including the notification content. The user notification may comprise the IP address of the user equipment of the user. The notification content may comprise a URL to access a service related to the user notification, particularly wherein the service is a web service. The notification content may comprise a notification text. The user notification type may be a quota exhaustion notification.

In a further embodiment of the method, the first entity is an application server, particularly a push notification server, a Service Capability Server (SCS) or a Mobile Network Operator Application Function, MNO AF; and wherein the second entity is a Network Exposure Function (NEF) a Service Capability Exposure Function (SCEF) a Charging Function (CHF) an Online Charging System (OCS) a Policy and Charging Rules Function (PCRF) or a Policy Control Function (PCF).

This disclosure also provides mobile network nodes, particularly a network node 600, and an application server 700, each configured to perform the respective methods as described herein. This disclosure also provides the corresponding computer program and computer program products comprising code, for example in the form of a computer program, that when run on processing circuitry of the mobile network nodes causes the mobile network nodes to perform the disclosed methods.

Advantageously, the solution disclosed herein enables the usage of an application handled by the operator towards its subscribers for the quota exhaustion notifications. That is, the application usually offered by operators so that the users can manage their subscription package. Using the solution disclosed herein, the quota exhaustion notifications can be displayed as notifications of the operator's application.

Hereinafter, drawings showing examples of embodiments of the solution are described in detail.

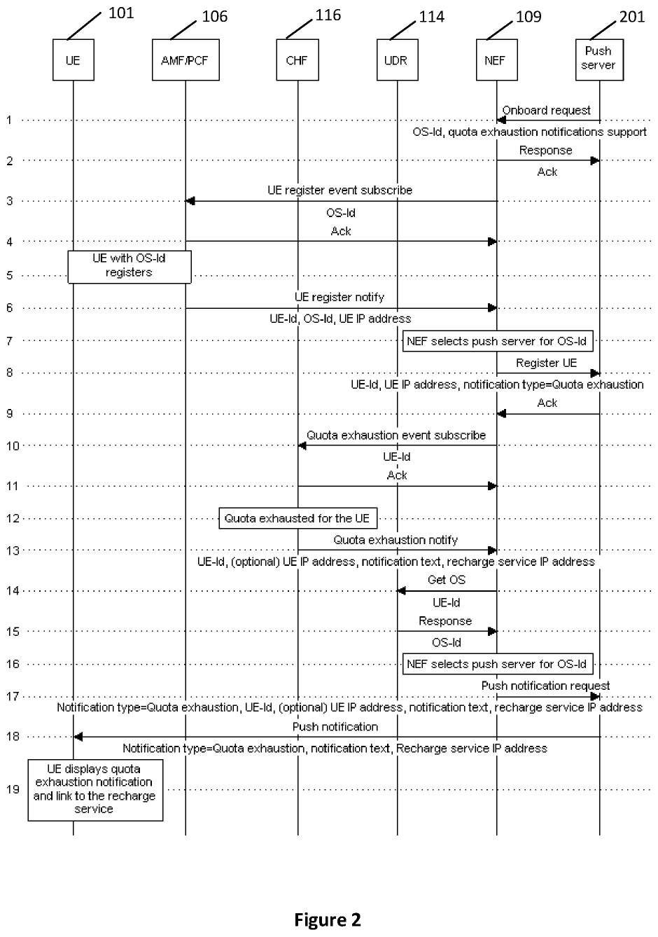

FIG. 2 is a signaling diagram illustrating a procedure for quota exhaustion notifications in a communications network. The procedure uses push notifications that are not linked to a specific application. The procedure is performed by an application server (e.g. a push server) 201, a NEF 109, a CHF 116, an AFM 106, a PCF 111, a UE 101 and a UDR 114.

At step 1, the push notification server onboards to the operator's network (via NEF) including the operating system identifier (OS-Id) and an indication of the quota exhaustion notifications support (indication that the push server supports notifications for quota management).

At step 2, the NEF acknowledges the onboard request.

At step 3, the NEF registers to the AMF/PCF for UE registration events for UEs of a certain OS-ID.

At step 4, the AMF/PCF acknowledges the subscription request.

At step 5, a UE with the OS (OS-ID) registers in the operator's network.

At step 6, the AMF/PCF notifies the NEF of the UE register event including the UE-Id, the OS-Id and the UE IP address.

At step 7, the NEF selects the push server for the OS-Id

At step 8, the NEF registers the UE in the push server including the UE-Id, the UE IP address, and the Notification type=Quota exhaustion.

At step 9, the push server acknowledges the registration.

At step 10, the NEF subscribes to the CHF for Quota exhaustion events including the UE-ID.

At step 11, the CHF acknowledges the subscription.

At step 12, the quota is exhausted or about to be exhausted for the UE.

At step 13, the CHF sends a quota exhaustion notify to the NEF including the UE-Id, (optional) the UE IP address (if not sent in step 8), the notification text (e.g. “quota is about to exhaust”, or “quota is exhausted, please refill”) and the recharge service IP address (IP address of the quota refilling service).

At step 14, the NEF obtains information on the OS of the UE by sending a request to UDR. This step only takes place if the NEF has not previously stored the OS-ID for the UE-ID.

At step 15, the UDR sends the OS-ID of the UE to the NEF in response to the request in step 14.

At step 16, the NEF selects the push server for the OS-Id (the same as step 7).

At step 17, the NEF sends a push notification request to the push Server including the Notification type=Quota exhaustion, the UE-Id, (optional) UE IP address (if not sent in step 8), the notification text (e.g. “quota is about to exhaust”, or “quota is exhausted, please refill”) and the recharge service IP address (IP address of the quota refilling service).

At step 18, the push server sends the push notification to the UE including the Notification type=Quota exhaustion, the notification text (e.g. “quota is about to exhaust”, or “quota is exhausted, please refill”) and the recharge service IP address (IP address of the quota refilling service).

At step 19, the UE displays a quota exhaustion notification and/or a link to the recharge service.

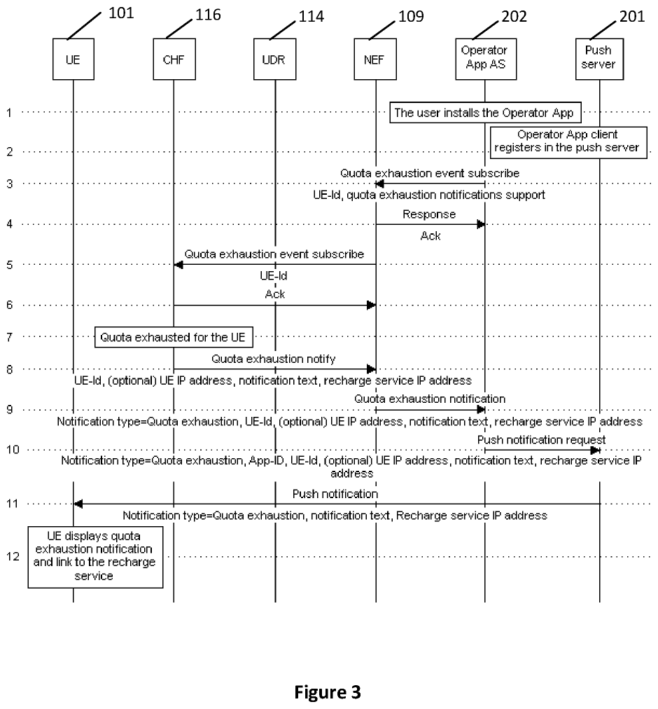

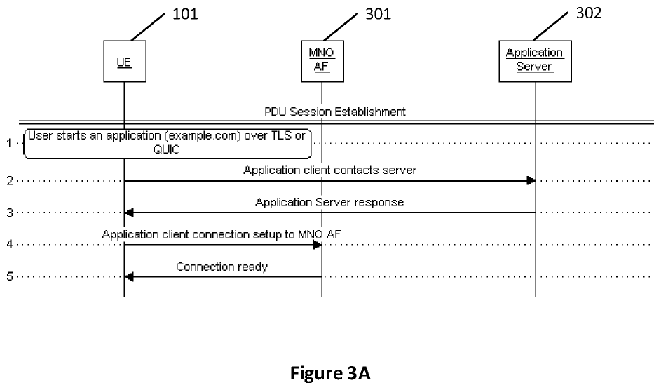

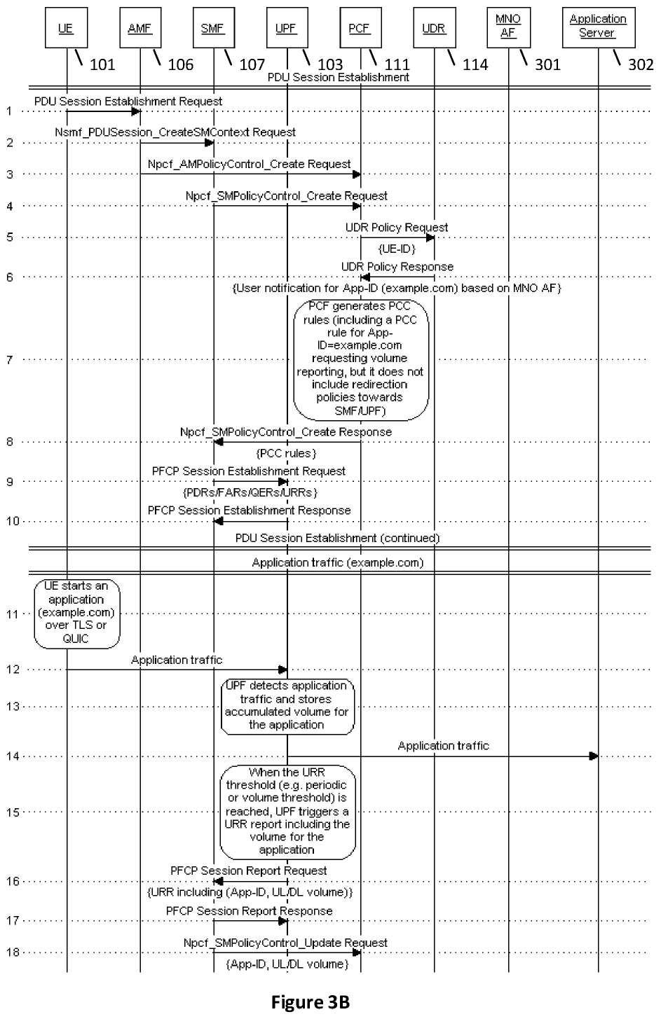

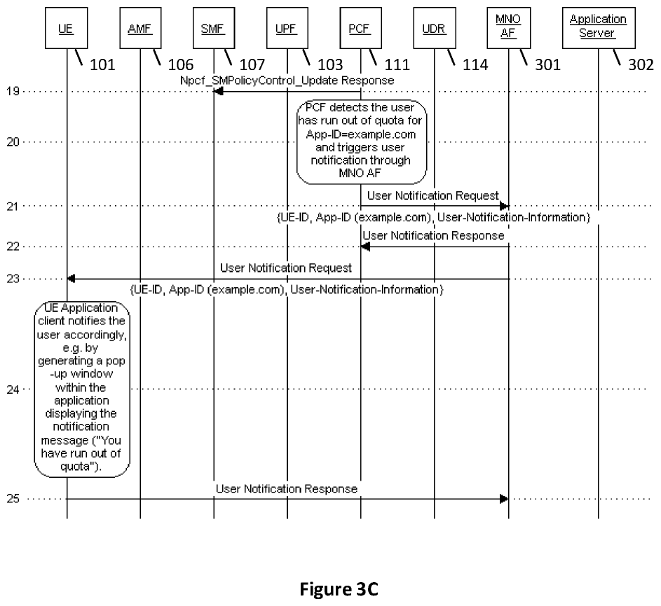

FIG. 3 is a signaling diagram illustrating a procedure for quota exhaustion notifications in a communications network. The procedure uses push notifications that are linked to a specific application. The procedure is performed by an application server (e.g. a push server) 201, an application server of the operator's application 202, a NEF 109, a CHF 116, a UE 101 and a UDR 114.

At step 1, the user installs the operator application. The operator's application server (AS) detects this event, e.g. when the user installs the application and logs in for the first time.

At step 2, the operator application client registers in the push server via existing mechanisms.

At step 3, the operator application AS sends a quota exhaustion event subscribe message to the operator's network (via NEF) including a UE-ID and a quota exhaustion notifications support indication, indicating that the Operator application AS supports notifications for quota management.

At step 4, the NEF acknowledges the subscribe message of step 3.

At step 5, the NEF subscribes to the CHF for quota exhaustion events including the UE-ID.

At step 6, CHF acknowledges the subscription.

At step 7, the quota is exhausted or about to be exhausted for the UE.

At step 8, the CHF sends a quota exhaustion notify to the NEF including the UE-Id, (optional) the UE IP address, the notification text (e.g. “quota is about to exhaust”, or “quota is exhausted, please refill”) and the recharge service IP address (IP address of the quota refilling service).

At step 9, the NEF sends a quota exhaustion notification to the Operator application AS including a Notification type=Quota exhaustion, the UE-Id, (optional) the UE IP address, the notification text (e.g. “quota is about to exhaust”, or “quota is exhausted, please refill”) and the recharge service IP address (IP address of the quota refilling service).

At step 10, the operator application AS sends a push notification request to the push Server including the Notification type=Quota exhaustion, the application-ID (to identify the application), the UE-Id, (optional) the UE IP address, the notification text (e.g. “quota is about to exhaust”, or “quota is exhausted, please refill”) and the recharge service IP address (IP address of the quota refilling service).

At step 11, the push server sends the push notification to the UE including the Notification type=Quota exhaustion, the notification text (e.g. “quota is about to exhaust”, or “quota is exhausted, please refill”) and/or the recharge service IP address (IP address of the quota refilling service).

At step 12, the UE displays quota exhaustion notification and link to the recharge service.

FIGS. 3A, 3B and 3C show the scenario in which an MNO AF is used.

FIG. 3A is a signaling diagram illustrating the UE connection to the MNO AF. It is assumed there is an SLA agreement between the Content Provider and the Mobile Network Operator to support the user notification mechanism using the MNO AF. The procedure is performed by a UE 101, an MNO AF 301 and an application server 302.

At step 1, the UE starts an application.

At step 2, the Application Client may contact the Application Server, for example for initial synchronization.

At step 3, the Application Client may receive data (e.g. FQDN or IP address) needed for the user plane connection to the MNO AF. This data might also be pre-provisioned in the Application Client.

At step 4, the Application Client sets up a user plane connection (e.g. HTTPS) over the existing PDU session to the MNO AF. Multiple user plane connections may be established. A single user plane connection may be also established for different applications between the UE and MNO AF. When this connection is setup, the Application Client provides the App-ID and UE-ID, that will be stored in the MNO AF.

At step 5, the MNO AF answers to the UE indicating the connection between UE (Application Client) and MNO AF is ready for use.

FIGS. 3B and 3C depict a signaling diagram illustrating a procedure for quota exhaustion notifications in a communications network using an MNO AF. The procedure is performed by an application server 302, an MNO AF 301, a UE 101, an AMF 106, a SMF 107, a UPF 103, a PCF 111 and a UDR 114. A NEF 109 may be used as intermediary in the interactions between the MNO AF and the other entities. The description of the steps is as follows.

Steps 1 to 4) The UE triggers the PDU Session Establishment procedure. As part of this procedure, the AMF creates the policy association with the PCF (Step 3) and SMF creates the policy association with the PCF (Step 4).

Steps 5 and 6) The PCF retrieves from the UDR the subscriber policy for UE-ID, which includes an indication of the support of User Notifications for an App-ID based on the MNO AF. This indicates the PCF to provision the corresponding policies to the MNO AF instead of following the regular policy provisioning procedures (e.g. via the SMF).

Steps 7 and 8) The PCF generates the PCC rules including a PCC rule for the App-ID requesting volume reporting. Based on the above indication on User Notification based on MNO AF, the PCF does not include any redirection policy towards SMF/UPF.

Steps 9 and 10) The SMF triggers the PFCP Session Establishment procedure towards UPF to indicate the PDRs and the corresponding enforcement actions (FARs, QERS, URRs, etc) for the PDU session. Specifically, SMF will include an UL/DL PDR with PDI type App-ID which is associated to a URR to report volume usage for the application.

Steps 11 and 12) The UE starts the application corresponding to the App-ID.

Steps 13 and 14) The UPF detects application traffic (by matching UL PDR with PDI App-ID), calculates and stores the accumulated volume for the application.

Steps 15 to 17) When the URR threshold (e.g. periodic or volume threshold) is reached, the UPF triggers a URR report in the PFCP Session Report Request message including the volume usage for the application. The SMF answers with a PFCP Session Report Response message.

Step 18 and 19) The SMF reports the application volume to the PCF in a Npcf_SMPolicyControl_Update Request message. PCF answers back to SMF with a Npcf_SMPolicyControl_Update Response message.

Steps 20 and 21) The PCF detects the user has run out of quota for the App-ID (e.g. accumulated volume for the current month exceeds a threshold) and based on the indication received from UDR in Step 6, it first discovers the MNO AF instance for user notification for App-ID. For the MNO AF discovery the MNO AF shall register in the NRF, and the PCF shall discover the MNO AF using the existing NRF mechanisms. The PCF requests to the discovered MNO AF instance to trigger user notification, by sending a User Notification Request message including the following parameters:
UE-ID
App-ID
User-Notification-Information, which includes:
   User-Notification-Source, which can include either:
      Notification message, e.g. “You have run out of quota” so the message is directly conveyed to the user, without the need to trigger a connection towards a Notification Server (e.g. a top-up server).
      OR
      Notification Server URI: Determines the URI where the user needs to connect to for notification purposes. It can instead be a server IP address (e.g. of the network operator's top-up server).
   User-Notification-Type: Determines the type of user notification as follows:
      One-time notification: user notification needs to be triggered only once (e.g. user notification in case of roaming with potential extra charges).
      Continuous notification: notification needs to be triggered continuously (e.g. in case the user is out of quota and needs to be continuously redirected).
   User-Notification-Access-Control-Policy: Determines the access control policy for the user application traffic, as follows:
      Allow: allows the user application traffic to pass while the User Notification policy is active.
      Block: blocks the user application traffic while the User Notification policy is active.

Step 22) The MNO AF answers to the PCF with a User Notification Response message indicating successful operation.

Step 23) The MNO AF finds the connection (previously setup as per the procedure described above) for the UE-ID and the App-ID and requests the Application client at UE (UE-ID) to notify the user by triggering a User Notification Request message including the same information as in the message in Step 21 (UE-ID, App-ID and User-Notification-Information).

Step 24) The UE Application client notifies the user accordingly, e.g. by generating a pop-up window within the application displaying the notification message (“You have run out of quota”). In case the UE Application client tries to send further application traffic, extra pop-up windows might be generated within the application to display the notification message (if User-Notification-Type is set to “Continuous Notification”). Additionally, the UE Application client might block traffic (if User-Notification-Access-Control-Policy is set to “Block”). Not shown in the figure, but in case User-Notification-Source includes a Notification Server URI or IP address (e.g. MNO's top-up server), the UE Application client may trigger a connection to it, e.g. HTTP(S) GET message. In this case, the MNO's top-up server answers back to the UE Application client with a HTTP(S) 200 OK message indicating the UE has run out of quota.

Step 25) When the user has been notified, the UE Application client answers to the MNO AF with a User Notification Response message indicating successful operation.

Finally, not shown in the example in the sequence diagram, but in case the user runs out of quota for an Internet package (not tied to any specific application or a set of applications like a social network bundle), the mechanism described in this IvD can also be used, e.g. by setting App-ID to be the MNO's own application. In this case, the user will be notified through the MNO's own application. The same applies to other user notification Use Cases not related to running out of quota, e.g. when MNO wants to notify the user of any event (e.g. user entering roaming which might be subject to extra charging). In this case, the user will be notified through the MNO's own application.

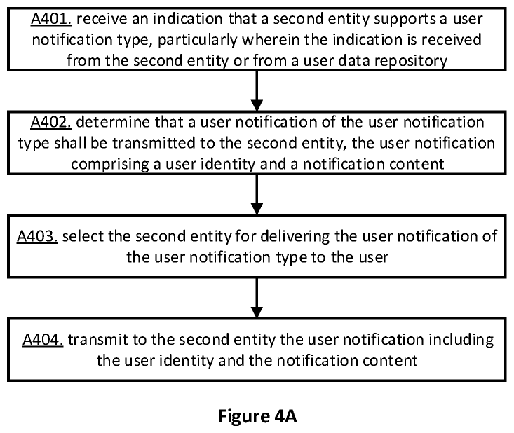

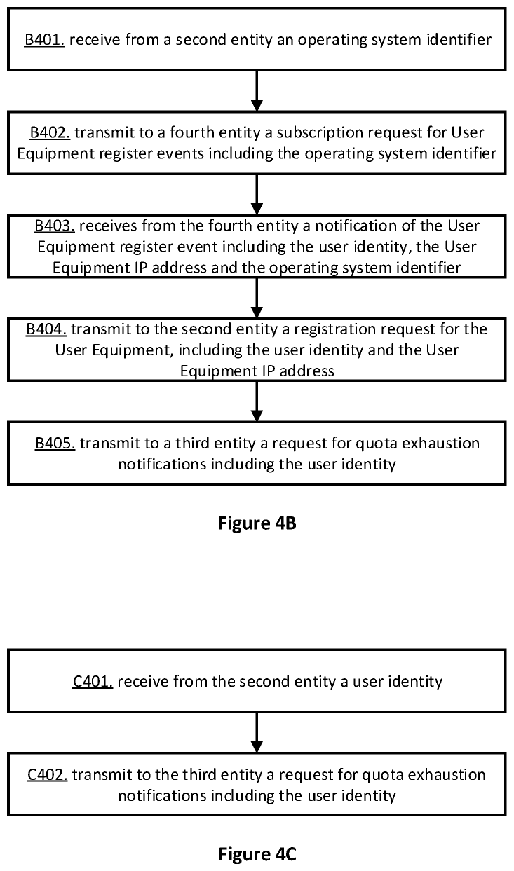

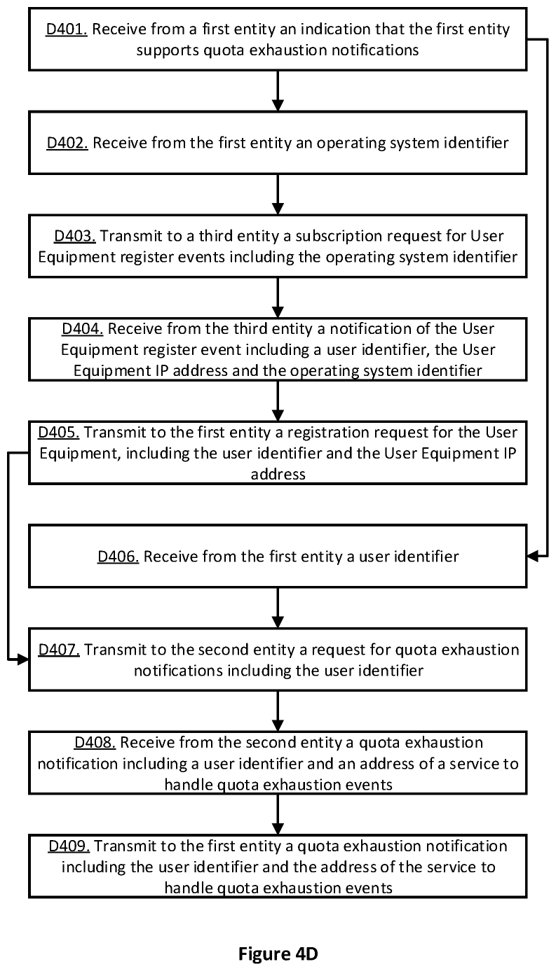

FIG. 4A is a flowchart illustrating a method performed by an apparatus for quota exhaustion notifications in a communications network, the apparatus comprising a processor and a memory, the memory containing instructions executable by the processor. The apparatus may be a Network Exposure Function (NEF) 109, a Service Capability Exposure Function (SCEF) 802, a Policy and Charging Rules Function (PCRF) 804, a Policy Control Function (PCF) 111, a Charging Function (CHF) 116 an Online Charging System (OCS) 805.

At step A401, the apparatus receives an indication that a second entity supports a user notification type, particularly wherein the indication is received from the second entity or from a user data repository.

At step A402, the apparatus determines that a user notification of the user notification type shall be transmitted to the second entity, the user notification comprising a user identity and a notification content.

At step A403, the apparatus selects the second entity for delivering the user notification of the user notification type to the user.

At step A404, the apparatus transmits to the second entity the user notification including the user identity and the notification content.

The second entity may be an application server, particularly a push notification server 201, a Service Capability Server (SCS) 801 or a Mobile Network Operator Application Function (MNO AF) 301.

FIG. 4B is a flowchart illustrating a method performed by an apparatus for quota exhaustion notifications in a communications network, the apparatus comprising a processor and a memory, the memory containing instructions executable by the processor. The apparatus may be a Network Exposure Function (NEF) 109, or a Service Capability Exposure Function (SCEF) 802.

At step B401, the apparatus receives from a second entity an operating system identifier.

At step B402, the apparatus transmits to a fourth entity a subscription request for User Equipment register events including the operating system identifier.

At step B403, the apparatus receives from the fourth entity, in response to a register event of a User Equipment whose operating system corresponds to the operating system identifier, a notification of the User Equipment register event including the user identity, the User Equipment IP address and the operating system identifier.

At step B404, the apparatus transmits to the second entity a registration request for the User Equipment, including the user identity and the User Equipment IP address.

At step B405, the apparatus transmits to a third entity a request for quota exhaustion notifications including the user identity.

The second entity may be an application server, particularly a push notification server 201, a Service Capability Server (SCS) 801 or a Mobile Network Operator Application Function (MNO AF) 301. The third entity may be a Charging Function (CHF) 116, an Online Charging System (OCS) 805, a Policy and Charging Rules Function (PCRF) 804, or a Policy Control Function (PCF) 111. The fourth entity may be an Access and Mobility Management Function (AMF) 106, a Policy Control Function (PCF) 111, a Mobility Management Entity (MME) 803 or a Policy and Charging Rules Function (PCRF) 804.

FIG. 4C is a flowchart illustrating a method performed by an apparatus for quota exhaustion notifications in a communications network, the apparatus comprising a processor and a memory, the memory containing instructions executable by the processor. The apparatus may be a Network Exposure Function (NEF) 109, or a Service Capability Exposure Function (SCEF) 802.

At step C401, the apparatus receives from the second entity a user identity.

At step C402, the apparatus transmits to the third entity a request for quota exhaustion notifications including the user identity.

The second entity may be an application server, particularly a push notification server 201, a Service Capability Server (SCS) 801 or a Mobile Network Operator Application Function (MNO AF) 301. The third entity may be a Charging Function (CHF) 116, an Online Charging System (OCS) 805, a Policy and Charging Rules Function (PCRF) 804, or a Policy Control Function (PCF) 111.

FIG. 4D is a flowchart illustrating a method performed by an apparatus for quota exhaustion notifications in a communications network, the apparatus comprising a processor and a memory, the memory containing instructions executable by the processor. The apparatus may be a Network Exposure Function (NEF) 109, or a Service Capability Exposure Function (SCEF) 802.

At step D401, the apparatus receives from a second entity an indication that the second entity supports quota exhaustion notifications.

At step D402, the apparatus receives from the second entity an operating system identifier.

At step D403, the apparatus transmits to a second entity a subscription request for User Equipment register events including the operating system identifier.

At step D404, the apparatus receives from the second entity a notification of the User Equipment register event including a user identity, the User Equipment IP address and the operating system identifier.

At step D405, the apparatus transmits to the second entity a registration request for the User Equipment, including the user identity and the User Equipment IP address.

At step D406, the apparatus receives from the second entity a user identity.

At step D407, the apparatus transmits to the third entity a request for quota exhaustion notifications including the user identity.

At step D408, the apparatus receives from the third entity a quota exhaustion notification including a user identity and an address of a service to handle quota exhaustion events.

At step D409, the apparatus transmits to the second entity a quota exhaustion notification including the user identity and the address of the service to handle quota exhaustion events.

The second entity may be an application server, particularly a push notification server 201 or a Service Capability Server (SCS) 801. The third entity may be a Charging Function (CHF) 116, or an Online Charging System (OCS) 805. The second entity may be an Access and Mobility Management Function (AMF) 106, a Policy Control Function (PCF) 111, a Mobility Management Entity (MME) 803 or a Policy and Charging Rules Function (PCRF) 804.

The quota exhaustion notification received from the third entity and the quota exhaustion notification transmitted to the second entity may further include at least one of the IP address of the User Equipment of the user and the text of the notification.

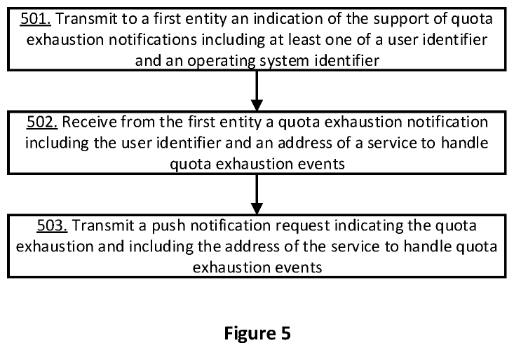

FIG. 5 is a flowchart illustrating a method performed by an apparatus for quota exhaustion notifications in a communications network, the apparatus comprising a processor and a memory, the memory containing instructions executable by the processor. The apparatus may be an application server or a Service Capability Server (SCS) 801.

At step 501, the apparatus transmits to a second entity an indication of the support of quota exhaustion notifications including at least one of a user identity and an operating system identifier.

At step 502, the apparatus receives from the second entity a quota exhaustion notification including the user identity and an address of a service to handle quota exhaustion events.

At step 503, the apparatus transmits a push notification request indicating the quota exhaustion and including the address of the service to handle quota exhaustion events.

The second entity may be a Network Exposure Function (NEF) 109, or a Service Capability Exposure Function (SCEF) 802.

The quota exhaustion notification received from the second entity and the push notification request may further include at least one of the IP address of the User Equipment of a user identified by the user identity and the text of the notification.

The application server may be a push notification server and the push notification request may be transmitted to the User Equipment.

The push notification request may be transmitted to a second application server which in turn transmits a second push notification request to the User Equipment. The second application server may be a push notification server in this case.

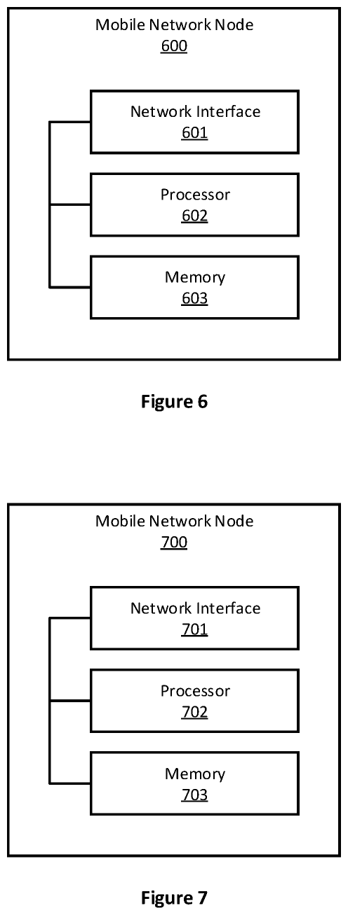

FIG. 6 is a block diagram illustrating elements of a mobile network node 600 of a mobile communications network. In some embodiments, the mobile network node 600 is a Network Exposure Function (NEF) 109, a Service Capability Exposure Function (SCEF) 802, a Policy and Charging Rules Function (PCRF) 804, a Policy Control Function (PCF) 111, a Charging Function (CHF) 116 an Online Charging System (OCS) 805. As shown, the mobile network node may include network interface circuitry 601 (also referred to as a network interface) configured to provide communications with other nodes of the core network and/or the network. The mobile network node may also include a processing circuitry 602 (also referred to as a processor) coupled to the network interface circuitry, and memory circuitry 603 (also referred to as memory) coupled to the processing circuitry. The memory circuitry 603 may include computer readable program code that when executed by the processing circuitry 602 causes the processing circuitry to perform operations according to embodiments disclosed herein. According to other embodiments, processing circuitry 602 may be defined to include memory so that a separate memory circuitry is not required. As discussed herein, operations of the mobile network node may be performed by processing circuitry 602 and/or network interface circuitry 601. For example, processing circuitry 602 may control network interface circuitry 601 to transmit communications through network interface circuitry 601 to one or more other network nodes and/or to receive communications through network interface circuitry from one or more other network nodes. Moreover, modules may be stored in memory 603, and these modules may provide instructions so that when instructions of a module are executed by processing circuitry 602, processing circuitry 602 performs respective operations (e.g., operations discussed below with respect to Example Embodiments relating to core network nodes).

FIG. 7 is a block diagram illustrating elements of a mobile network node 700 of a mobile communications network. In some embodiments, the mobile network node 700 is an application server, particularly a push notification server 201, a Service Capability Server (SCS) 801 or a Mobile Network Operator Application Function (MNO AF) 301. As shown, the mobile network node may include network interface circuitry 701 (also referred to as a network interface) configured to provide communications with other nodes of the core network and/or the network. The mobile network node may also include a processing circuitry 702 (also referred to as a processor) coupled to the network interface circuitry, and memory circuitry 703 (also referred to as memory) coupled to the processing circuitry. The memory circuitry 703 may include computer readable program code that when executed by the processing circuitry 702 causes the processing circuitry to perform operations according to embodiments disclosed herein. According to other embodiments, processing circuitry 702 may be defined to include memory so that a separate memory circuitry is not required. As discussed herein, operations of the mobile network node may be performed by processing circuitry 702 and/or network interface circuitry 701. For example, processing circuitry 702 may control network interface circuitry 701 to transmit communications through network interface circuitry 701 to one or more other network nodes and/or to receive communications through network interface circuitry from one or more other network nodes. Moreover, modules may be stored in memory 703, and these modules may provide instructions so that when instructions of a module are executed by processing circuitry 702, processing circuitry 702 performs respective operations (e.g., operations discussed below with respect to Example Embodiments relating to core network nodes).

1-21. (canceled)

22. A method performed by a first entity for handling user notifications in a communications network, the method comprising:
receiving an indication that a second entity supports a user notification type;
determining that a user notification of the user notification type shall be transmitted to a user equipment associated with a subscriber of the communications network, the user notification comprising a user identity of the subscriber and a notification content;
selecting the second entity for delivering the user notification of the user notification type to the user equipment;
transmitting to the second entity the user notification including the user identity and the notification content.

23. The method of claim 22, wherein the indication is received from the second entity or from a user data repository.

24. The method of claim 22, further comprising receiving from a third entity a notify message including the user identity and the notification content, wherein the transmission of the user notification is determined based on the received notify message.

25. The method of claim 22, wherein the user notification and/or notify message further include the IP address of the user equipment of the user.

26. The method of claim 22, wherein the notification content comprises a URL to access a service related to the user notification, particularly wherein the service is a web service.

27. The method of claim 22, wherein the notification content comprises a notification text.

28. The method of claim 22, further comprising:
receiving from the second entity an operating system identifier;
transmitting to a fourth entity a subscription request for user equipment register events including the operating system identifier;
receiving from the fourth entity, in response to a register event of the user equipment, wherein the operating system of the user equipment corresponds to the operating system identifier, a notification of the user equipment register event including the user identity, an IP address of the user equipment and the operating system identifier;
transmitting to the second entity a registration request for the user equipment, including the user identity and the IP address; and
transmitting to the third entity a request for quota exhaustion notifications including the user identity.

29. The method of claim 22, further comprising:
receiving from the second entity a user identity; and
transmitting to the third entity a request for quota exhaustion notifications including the user identity;

30. The method of claim 22, wherein the user notification type is a quota exhaustion notification.

31. The method of claim 22, wherein the first entity is a Network Exposure Function, NEF, a Service Capability Exposure Function, SCEF, a Policy and Charging Rules Function, PCRF, a Policy Control Function, PCF, a Charging Function, CHF, or an Online Charging System, OCS; wherein the second entity is an application server, particularly a push notification server, a Service Capability Server, SCS, or a Mobile Network Operator Application Function, MNO AF.

32. The method of claim 22, wherein the first entity is a Network Exposure Function, NEF, a Service Capability Exposure Function, SCEF; wherein the second entity is an application server, particularly a push notification server, a Service Capability Server, SCS, or a Mobile Network Operator Application Function, MNO AF; wherein the third entity is a Charging Function, CHF, an Online Charging System, OCS, a Policy and Charging Rules Function, PCRF, or a Policy Control Function, PCF; and wherein the fourth entity is an Access and Mobility Management Function, AMF, or a Mobility Management Entity, MME.

33. A method performed by a first entity for handling user notifications in a communications network, the method comprising:
transmitting to a second entity an indication of the support of a user notification type including at least one of a user identity of a subscriber of the communications network and an operating system identifier;
receiving from the second entity a user notification of the user notification type including the user identity and a notification content;
transmitting to a user equipment identified by the user identity a further user notification of the user notification type including the notification content.

34. The method of claim 33, wherein the user notification comprises the IP address of the user equipment of the user.

35. The method of claim 33, wherein the notification content comprises a URL to access a service related to the user notification, particularly wherein the service is a web service.

36. The method of claim 33, wherein the notification content comprises a notification text.

37. The method of claim 33, wherein the user notification type is quota exhaustion notification.

38. The method of claim 33, wherein the first entity is an application server, particularly a push notification server, a Service Capability Server, SCS, or a Mobile Network Operator Application Function, MNO AF; and wherein the second entity is a Network Exposure Function, NEF, a Service Capability Exposure Function, SCEF, a Charging Function, CHF, an Online Charging System, OCS, a Policy and Charging Rules Function, PCRF, or a Policy Control Function, PCF.

39. An apparatus for handling user notifications in a communications network, the apparatus comprising a processor and a memory, the memory containing instructions executable by the processor such that the apparatus is operable to
receive an indication that a second entity supports a user notification type;
determine that a user notification of the user notification type shall be transmitted to a user equipment associated with a subscriber of the communications network, the user notification comprising a user identity of the subscriber and a notification content;
select the second entity for delivering the user notification of the user notification type to the user

40. The apparatus of claim 39, wherein the indication is received from the second entity or from a user data repository
